(19) United States
(12) Patent Application Publication
(10) Pub. No.: US 2016/0194906 A1
(43) Pub. Date: Jul. 7, 2016

(54) Set-top Box Lock and Method of Use Thereof

(71) Applicant: COX COMMUNICATIONS, INC., Atlanta, GA (US)

(72) Inventors: Ingo Hentschel, Oceanside, CA (US); Scott Scrimiger, El Cajon, CA (US); Justin Hardin, El Cajon, CA (US); Chris Anderson, La Mesa, CA (US)

(73) Assignee: COX COMMUNICATIONS, INC., Atlanta, GA (US)

(21) Appl. No.: 14/588,817

(22) Filed: Jan. 2, 2015

(51) Int. Cl. E05B 73/00

(52) U.S. Cl. CPC E05B 73/00

(57) ABSTRACT

Example embodiments of a box lock include a base, a front lip, a back lip, a first side, a second side, and an openable top. The openable top is operable to insert a box onto the base and secure the box in the box lock between the first side and the second side, and the front lip and the back lip.

### TECHNICAL FIELD

The present disclosure is generally related to telecommunications and, more particularly, is related to a set-top box lock and method of use thereof.

### BACKGROUND

A set-top box (STB), also known as a set-top unit (STU), is an information appliance device that generally contains a TV-tuner input and provides output connects to a television set and an external source of signal, turning the source signal into content in a form that can then be displayed on the television screen or other display device. STBs may be used in cable television, satellite television, and over-the-air television systems, as well as other uses.

One problem associated with STBs is providing a device, means or method for securing or locking the STB in a desired location. For example, it may be desired to secure and/or lock an STB in a public place, like for use in a common area in a dorm or barrack. As another example, it may be desired to secure and/or lock an STB in a public area, like a bar or restaurant.

As such, there are heretofore unaddressed needs to provide a device, means or method to secure or lock STBs in a desired location. The instant disclosure is designed to address this issue.

### SUMMARY

Example embodiments of the present disclosure provide a box lock that may include a base, a front lip, a back lip, a first side, a second side, and an openable top. The openable top may be operable to insert a box, like a set-top box or other electronic appliance or component, onto the base and secure the box in the box lock between the first side and the second side, and the front lip and the back lip.

In one embodiment, the openable top may be hinged to the first side and lockable to the second side (or vice versa), whereby the openable top may be hingeable from a locked closed position to an open position for inserting and/or removing the box.

One feature may be the inclusion of a locking system for locking the openable top. In one embodiment, the locking system may include an overlap of the openable top beyond the second side, and a rod extending from the second side below the overlap. Whereby, the overlap of the openable top may be securable to the rod for locking the openable top in the locked closed position.

Another feature may be the ability of the locking system to be locked via a lock, like a locking pin or a padlock. As a non limiting example, the lock may secure the overlap of the openable top to the rod.

In one embodiment, the locking system may include a plate extending down from the overlap of the openable top including a first hole, and a second hole in the rod aligning with the first hole in the plate when in the closed position. Whereby, the lock may be inserted horizontally through the first and second holes for locking the openable top in the closed position.

In another embodiment, the locking system may include a third hole through the overlap, and a fourth hole in the rod aligning with the third hole in the overlap when in the closed position. Whereby, the lock may be inserted vertically through the third and fourth holes for locking the openable top in the closed position.

In select embodiments, the base may be sized to support a set-top box or STB. In this embodiment, the front lip may have a height sized to constrain the set-top box in the box lock and allow access to a front panel of the set-top box, and the back lip may have a height sized to constrain the set-top box in the box lock and allow access to a back panel of the set-top box. As examples, and clearly not limited thereto, the height of the front lip may be approximately 0.38 inches, and/or the height of the back lip may be approximately 0.38 inches.

Another feature may be the inclusion of at least one front cutout for lower access areas of the front panel in the front lip. As a non-limiting example, the front cutout may have a depth of approximately 0.13 inches.

Another feature may be the inclusion of at least one back cutout for lower access areas of the back panel in the back lip. As a non-limiting example, the back cutout may have a depth of approximately 0.13 inches.

Another feature may be the inclusion of a mounting means for mounting the box lock. In one embodiment, the mounting means may include a plurality of mounting holes through the base.

Another feature may be that the openable top, the first side, the second side, or combinations thereof may expand only a portion of for base for allowing air flow to the box.

The instant disclosure also includes a method of securing or locking a set-top box utilizing any of the various embodiments of the box lock as shown and/or described herein. The method may include: a step of providing the set-top box lock in any of the various embodiments shown and/or described herein; a step of removing and/or opening the openable top; a step of inserting the set-top box onto the base between the first side and the second side, and the front lip and the back lip; and a step of locking the openable top on the set-top box lock thereby securing the set-top box inside the set-top box lock.

In one embodiment of the method of securing and/or locking a set-top box, wherein the openable top being hinged to the first side and lockable to the second side (or vice versa), whereby the openable top being hingeable from a locked closed position to an open position for inserting and/or removing the box and the openable top being lockable to said second side via a locking system comprising: an overlap of the openable top beyond the second side, and a rod extending from the second side below the overlap; whereby, the overlap of the openable top being securable to the rod for locking the openable top in the locked closed position; and wherein the overlap of the openable top being securable to the rod via a lock, like a locking pin or padlock; the step of locking the openable top on the set-top box lock thereby securing the set-top box inside the set-top box lock may include: a step of inserting the lock between the overlap and the rod.

In another embodiment of the method of securing and/or locking a set-top box, wherein the lock, like the locking pin or padlock may be a keyed locking pin or keyed padlock, the step of locking the openable top on the set-top box lock thereby securing the set-top box inside the set-top box lock may further include: a step of locking lock between the overlap and the rod with the keyed locking pin or keyed lock.

In another embodiment of the method of securing or locking a set-top box, wherein the provided box lock including a mounting means for mounting the box lock, the method further including: a step of mounting the box lock via the mounting means prior to the step of inserting the set-top box onto the base between the first side and the second side, and the front lip and the back lip.

### BRIEF DESCRIPTION OF THE DRAWINGS

FIG. 1 is a perspective view of an example embodiment of a set-top box lock according to the instant disclosure.

FIG. 2A is a perspective view of the embodiment from FIG. 1 with the lock removed for opening the box lock.

FIG. 2B is a perspective view of the embodiment from FIG. 1 with the box lock opened and a set-top being positioned inside the box lock.

FIG. 2C is a perspective view of the embodiment from FIG. 1 with the set-top inserted into the box lock and the lock (locking pin) ready to be inserted for locking.

FIG. 2D is a perspective view of the embodiment from FIG. 1 with the set-top inserted into the box lock and locked (with padlock).

FIG. 3 is a front view of the embodiment shown in FIG. 1.

FIG. 4 is a first side view of the embodiment shown in FIG. 1.

FIG. 5 is a second side view of the embodiment shown in FIG. 1.

FIG. 6 is a back view of the embodiment shown in FIG. 1.

FIG. 7 is a top view of the embodiment shown in FIG. 1.

FIG. 8 is a bottom view of the embodiment shown in FIG. 1; and

FIG. 9 is a flow chart diagram of an example embodiment of the method of securing and/or locking a set-top box.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

The instant disclosure may be directed for set-top box lock 10, or box lock 10. Box lock 10 may be for securing box 24, like set-top box 58, in a desired location or to a desired structure. Although the instant disclosure may be directed to securing and/or locking set-top box 58, the disclosure should clearly not be limited thereto, and any other boxes or devices, including, but not limited to, electronic equipment, appliances, set-top boxes, set-top units, computers, the like, etc., may be secured and or locked with box lock 10. For example, it may be desired to utilize box lock 10 to secure and/or lock box 24, like set-top box 58, in a public place, like for use in a common area in a dorm or barrack. As another example, it may be desired to utilize box lock 10 to secure and/or lock box 24, like set-top box 58, in a public area, like a bar or restaurant.

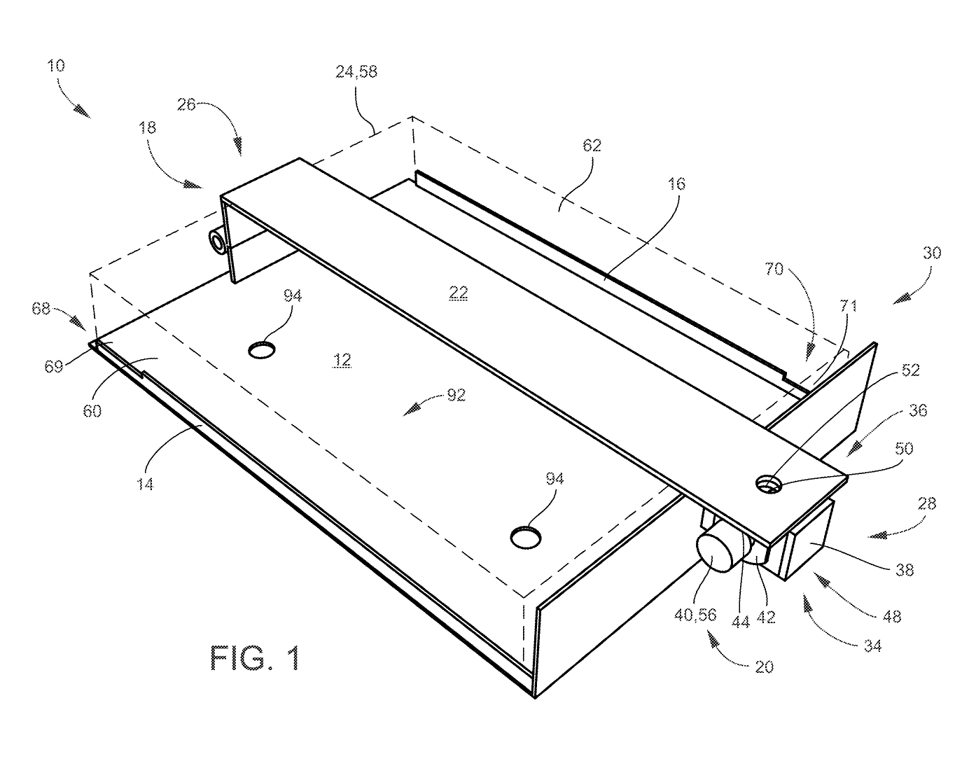

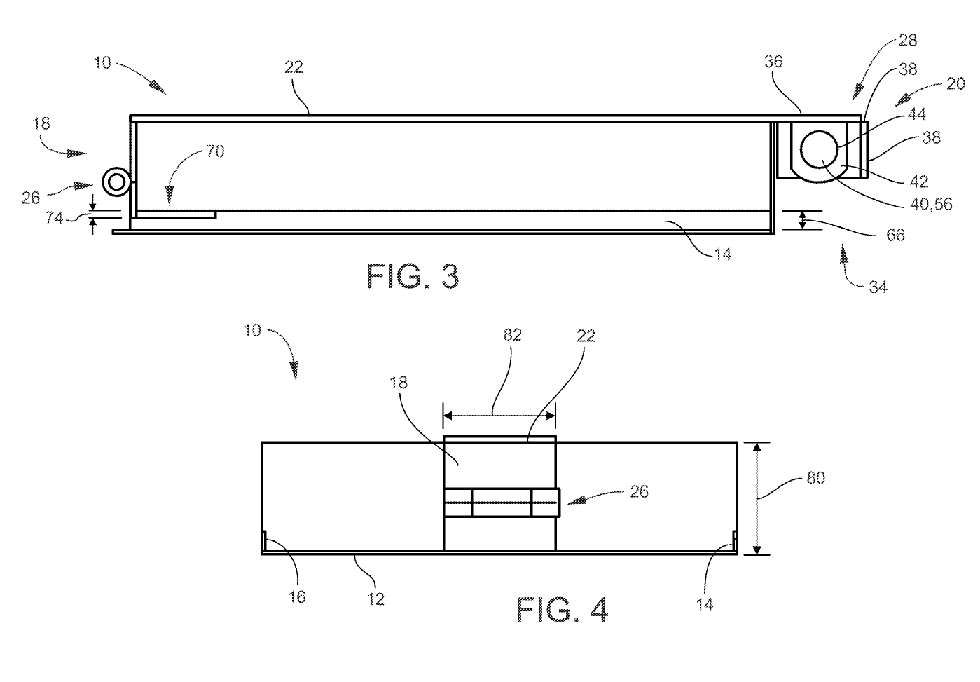

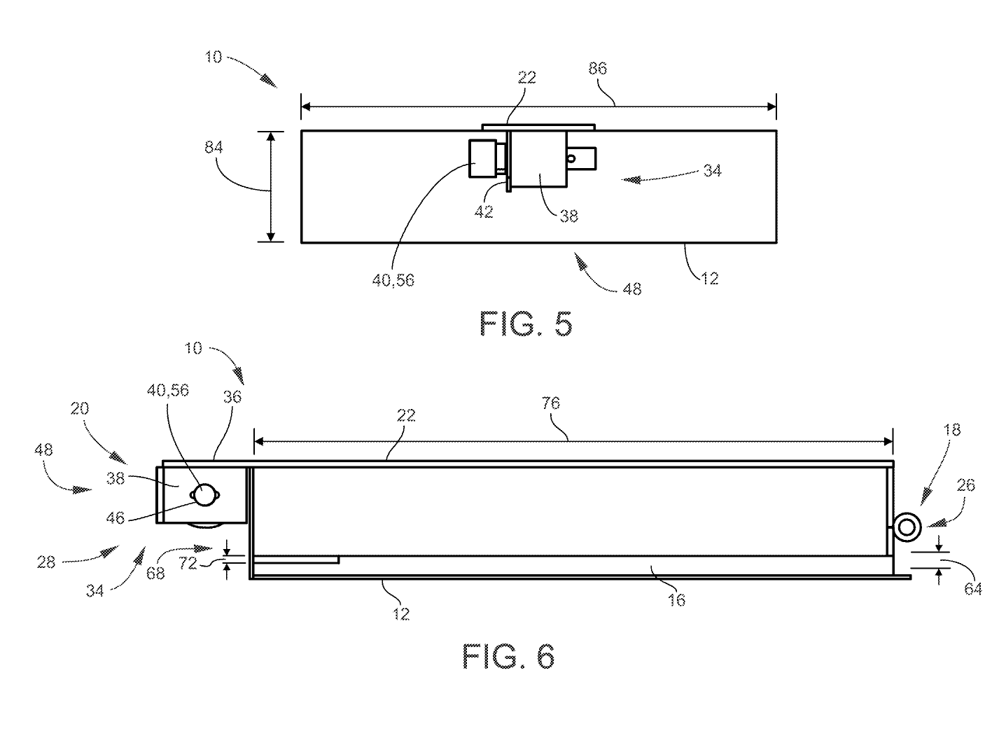

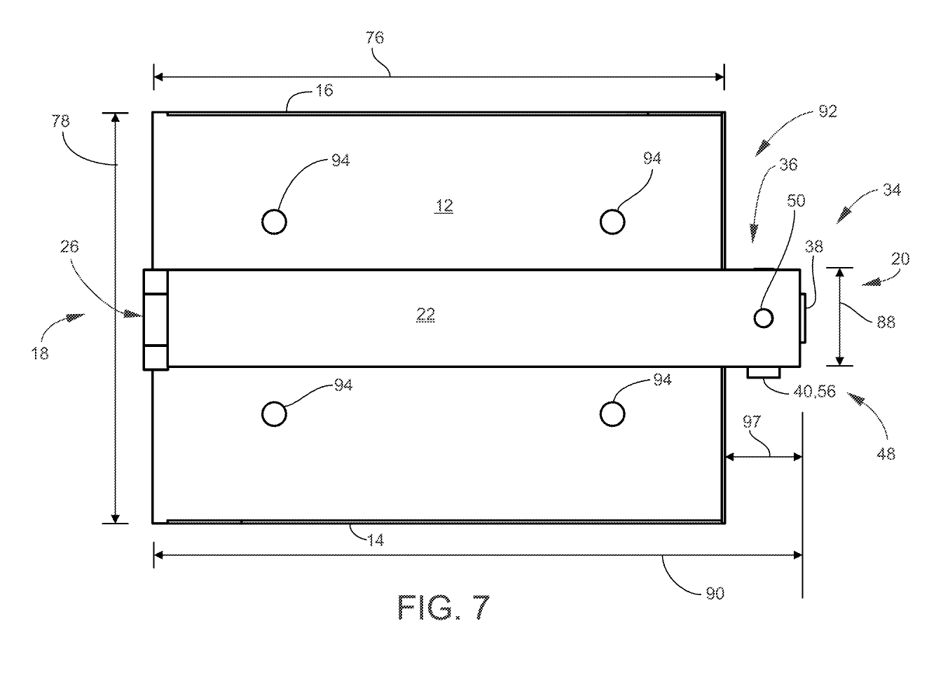

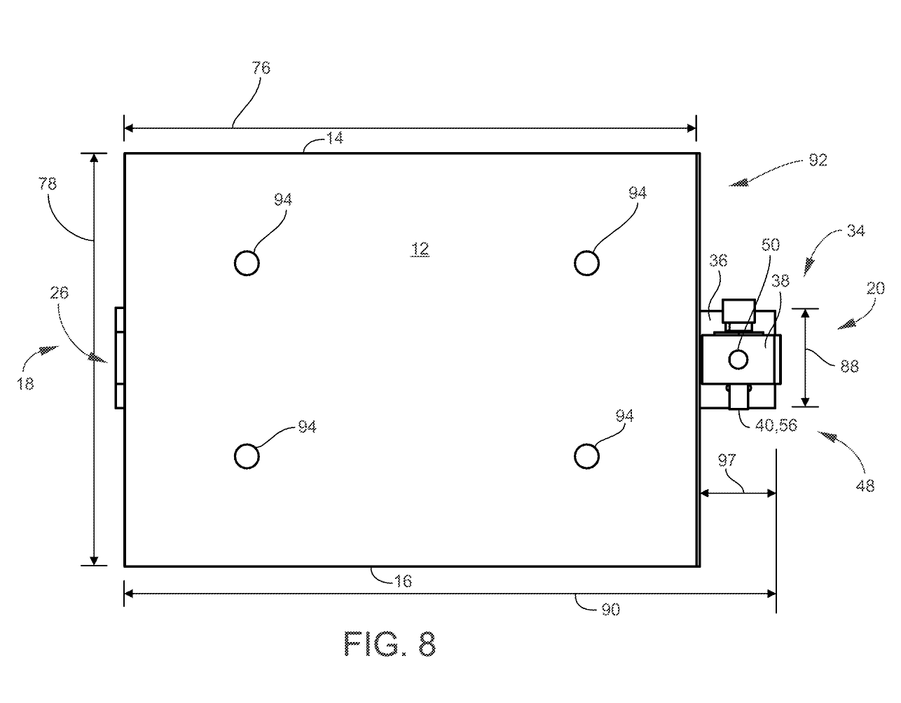

Referring now to FIGS. 1-8, by way of example, and not limitation, therein is illustrated example embodiments of the present disclosure of box lock 10, wherein box lock 10 can generally include base 12, front lip 14, back lip 16, first side 18, second side 20, and openable top 22. Openable top 22 may be operable to insert box 24, like set-top box 58 or other electronic appliances or component, onto base 12 and secure or lock box 24 in box lock 10 between first side 18 and second side 20, and between front lip 14 and back lip 16.

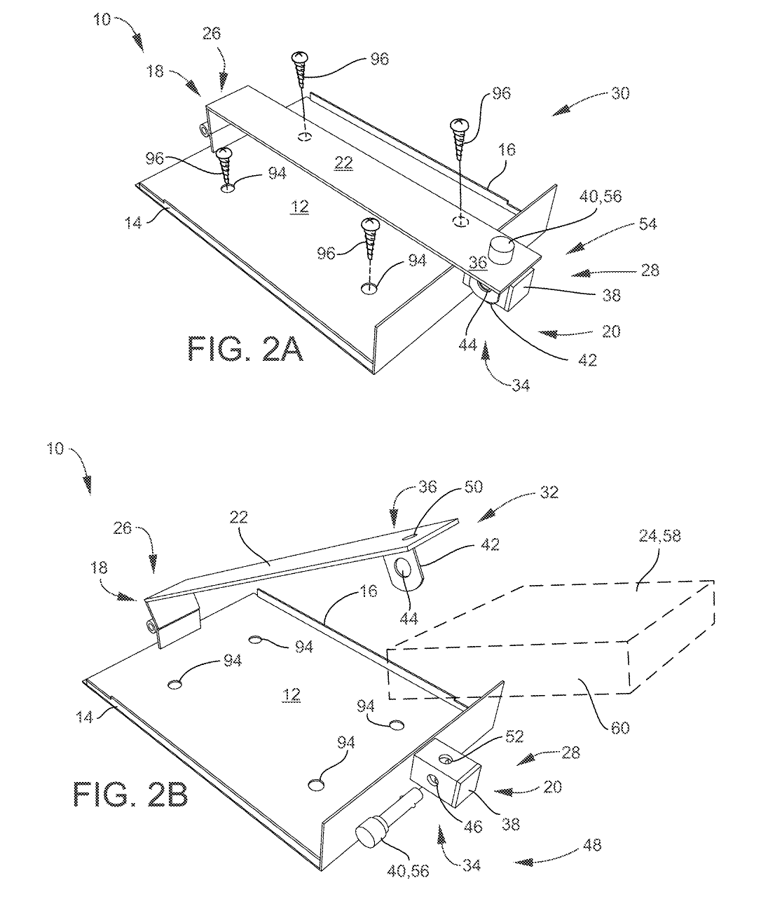

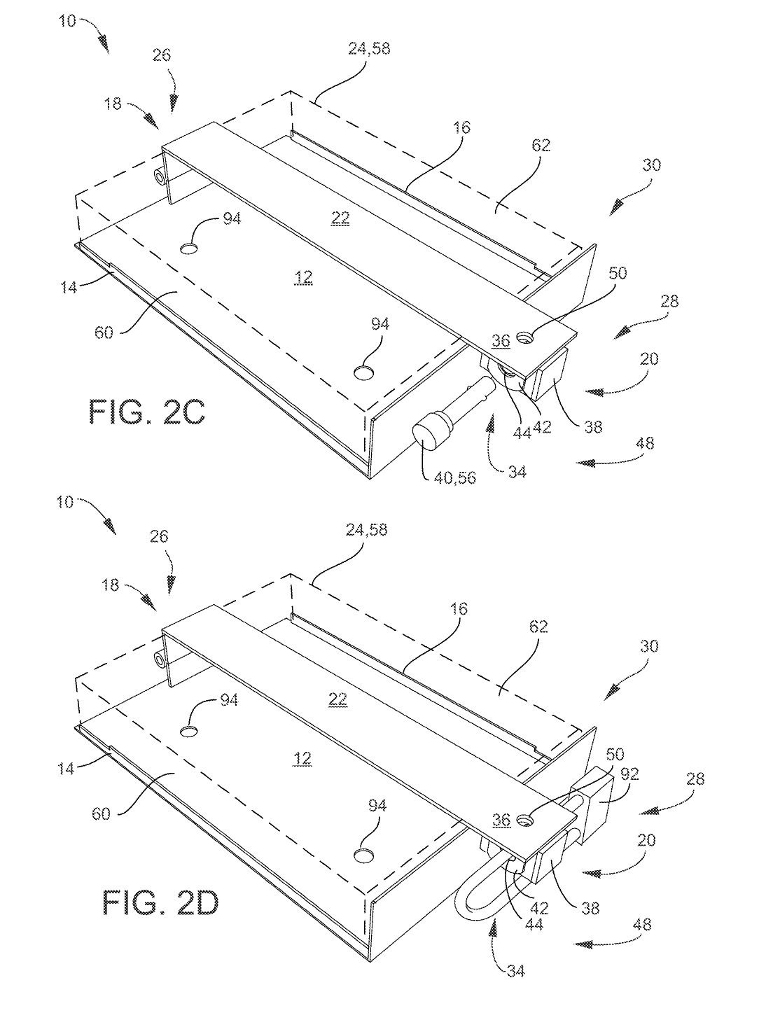

Openable top 22 may be removable from the top of first side 18 and/or second side 20, and front lip 14 and back lip 16 by any means. In one embodiment, openable top 22 may include hinge 26 to first side 18. Hinge 26 may allow openable top 22 to rotate off the top of first side 18 and second side 20, and front lip 14 and back lip 16, thereby providing access to box lock 10. Openable top 22 may also include lock 28 for locking to second side 20. As should be readily understood, hinge 26 and lock 28 may be reversible on first side 18 and second side 20. Whereby, openable top 22 may be hingeable from locked closed position 30 (see FIGS. 1, 2A, 2C, 2D, and 3-8) to open position 32 (see FIG. 2B) for inserting and/or removing box 24, like set-top box 58.

Openable top 22 may be locked in closed position 30 by any locking means. One feature of the instant disclosure may be the inclusion of locking system 34. Locking system 34 may be for locking openable top 22 in closed position 30 via lock 28. In select embodiments, locking system 34 may lock openable top 22 on first side 18 and/or second side 20. In one embodiment, locking system 34 may include overlap 36 and rod 38. Overlap 36 may be the portion of top 22 beyond second side 20 (or first side 18 in a reverse configuration). Rod 38 may extend from second side 20 (or first side 18 in a reverse configuration) below overlap 36. In combination, overlap 36 of openable top 22 may be securable to rod 38 for locking openable top 22 in locked closed position 30 via lock 28.

Lock 28 may be included with locking system 34 and may include any locking mechanism or means, including, but not limited to, locking pin 40 or padlock 92 (see FIG. 2D). Lock 28 may be for locking or securing locking system 34 by securing openable top 22 in closed position 30, like via locking pin 40 or padlock 92. However, as should be readily known by those skilled in the art, the disclosure is clearly not limited to use with locking pin 40 and/or padlock 92, and any device or means for locking or securing locking system 34 may be used. In select embodiments, lock 28 may be for securing overlap 36 to rod 38. Locking pin 40 may be any locking pin or like device, including, but not limited to, keyed locking pin 56. Keyed locking pin 56 may allow box lock 10 to be accessed by standard keys. For example, keyed locking pin 56 may allow service providers to equip employees with a key or universal key for accessing box lock 10. Padlock 92 may be any padlock or like device, including, but not limited to, any lock, padlock, ring, chain, the like, etc. For example, pad lock 92 may be a keyed or combination padlock 92.

In one embodiment, locking system 34 may include plate 42. Plate 42 may extend down from overlap 36 of openable top 22 and include first hole 44. Second hole 46 may be in rod 38 and may align with first hole 44 in plate 42 when openable top 22 may be in closed position 30. Whereby, locking pin 40 may be inserted horizontally in horizontal position 48 through first and second holes 44 and 46 for locking openable top 22 in closed position 30.

In another embodiment, locking system 34 may include third hole 50 through overlap 36, and fourth hole 52 in rod 38. Third hole 50 and fourth hole 52 may align when openable top 22 may be in closed position 30. Whereby, lock 28 may be inserted vertically in vertical position 54 through third and fourth holes 50 and 52 for locking openable top 22 in closed position 30.

As shown in the FIGS., in another embodiment, locking system 34 may include a combination of the above two embodiments for providing multiple locking configurations with horizontal position 48 or vertical position 54 of locking pin 40, padlock 92, or keyed locking pin 56.

In various embodiments, base 12 may be sized to support any desired box 24, including any desired set-top box 58. In select embodiments, front lip 14 may include height 64. Height 64 of front lip 14 may be sized high enough to constrain set-top box in box lock 10. In addition, height 64 of front lip 14 may be sized low enough to allow access to front panel 60 of set-top box 58. This may include any buttons, IR receivers, inputs, outputs, the like, etc. At least one front cutout 68 may be included in front lip 14. Front cutout 68 or cutouts 68 may be for lower access areas 69 of front panel 60 of box 24 in front lip 14 and may include any required depth 72. Likewise, back lip 16 may include height 66. Height 66 of back lip 16 may be sized high enough to constrain set-top box 58 in box lock 10. In addition, height 66 of back lip 16 may be sized low enough to allow access to back panel 62 of set-top box 58, including any buttons, receivers, inputs, outputs, the like, etc. At least one back cutout 70 may be included in back lip 16. Back cutout 70 or cutouts 70 may be for lower access areas 71 of back panel 62 of box 24 in back lip 16 and may include any required depth 74. As examples, and clearly not limited thereto, for use with a CISCO 4742HDC models set-top box, height 64 of front lip 14 may be approximately 0.38 inches, and height 66 of back lip 16 may be approximately 0.38 inches for adequate constraint of the set-top box and access to the front and back panels. Front cutout 68 and back cutout 70 may have depths 72 and 74 of approximately 0.13 inches. 12. In addition, for this CISCO 4742HDC models example, base 12 may have width 76 of 11.50 inches and depth 78 of 8.50 inches, first side 18 may have height 80 of 2.00 inches and width 82 of 2.92 inches; second side 20 may have height 84 of 2.00 inches and width 86 of 8.50 inches; and openable top 22 may have width 88 of 2.92 inches and length 90 of 13.00 inches, including an overlap 97 of approximately.1.500 inches. However, the invention is clearly not limited to these dimensions, and as should be readily understood by one skilled in the art, these dimensions and the size and shape of box lock 10 may be designed to fit any set-top box 58 or any other box 24.

Mounting means 92 may be included in select embodiments of box lock 10. Mounting means 92 may be for mounting and securing box lock 10 to a desired surface, device or location. Mounting means 92 may include any device, means, or combination thereof for mounting box lock 92. In select embodiments, as shown in the FIGS., mounting means 92 may include a plurality of mounting holes 94 through base 12. Whereby, a plurality of screws 96, or the like, may be operable to mount box lock 10. Because set-top box will be secured into box lock 10 via openable top 22, once mounted and locked, access to mounting holes 94 and screws 96 will be covered thereby preventing unauthorized removal of box lock 10.

One of the features of box lock 10 may be the ability to lock or secure box 24, like set-top box 58 with minimal restrictions to air flow to and from the device. As such, as shown in the FIGS., openable top 22, first side 18, second side 22, or combinations thereof may be designed to expand only a portion of base 12 for allowing air flow to box 24. For example, openable top 22 and/or first side 18 may expand approximately only ⅓ of depth 78 of base 12.

Referring now to FIGS. 2A-2D, these figures shown the general steps for utilizing box lock 10 for securing and/or locking box 24, like set-top box 58. As shown in FIG. 2A, if desired, one may first mount box lock 10 utilizing screws 96 (or the like) through mounting holes 94 in base 12. Next, as shown in FIG. 2B, with lock 28 (locking pin 40) removed, openable top 22 may be opened by rotating openable top 22 via hinge 26 to open position 32. Once open, box 24, like set-top box 58 may be inserted into box lock 10 on base 12 between first side 18 and second side 20, and front lip 14 and back lip 16. Once inserted, as shown in FIG. 2C, openable top 22 may be closed by rotating openable top 22 via hinge 26 to closed position 30. Finally, as shown in FIG. 2D, to secure and lock set-top box 58 inside box lock 10, lock 28 (padlock 92) may be inserted through overlap 36 and rod 38 in either horizontal position 48 or vertical position 54.

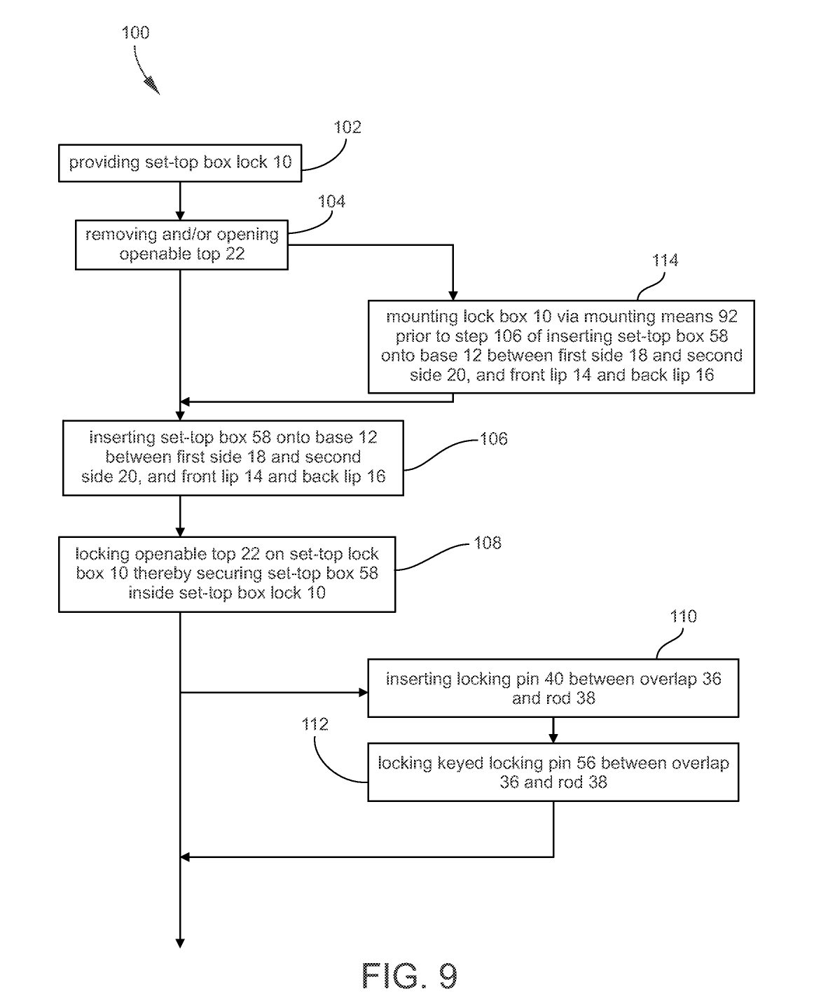

Referring now to FIG. 9, the instant disclosure also includes method 100 of securing and/or locking set-top box 58 utilizing any of the various embodiments of box lock 10 as shown and/or described herein. Method 100 may generally include: step 102 of providing set-top box lock 10 in any of the various embodiments shown and/or described herein; step 104 of removing and/or opening openable top 22; step 106 of inserting set-top box 58 onto base 12 between first side 18 and second side 20, and front lip 14 and back lip 16; and step 108 of locking openable top 22 on set-top box lock 10 thereby securing set-top box 58 inside set-top box lock 10.

In one embodiment of method 100 of securing and/or locking a set-top box, wherein openable top 22 may be hinged to first side 18 and lockable to second side 20 (or vice versa), whereby openable top 22 may be hingeable from locked closed position 30 to open position 32 for inserting and/or removing set-top box 58 and openable top 22 may be lockable to second side 20 via locking system 34 comprising: overlap 36 of openable top 22 beyond second side 20, and rod 38 extending from second side 20 below overlap 36; whereby, overlap 36 of openable top 22 may be securable to rod 38 for locking openable top 22 in locked closed position 30; and wherein overlap 36 of openable top 22 is securable to rod 38 via lock 28 (like locking pin 40 or padlock 92); step 108 of locking openable top 22 on set-top box lock 10 thereby securing set-top box 58 inside set-top box lock 10 may include: step 110 of inserting lock 28 (like locking pin 40 or padlock 92) between overlap 36 and rod 38.

In another embodiment of method 100 of securing and/or locking a set-top box, wherein locking pin 40 may be keyed locking pin 56, step 108 of locking openable top 22 on set-top box lock 10 thereby securing set-top box 58 inside set-top box lock 10 may further include: step 112 of locking keyed locking pin 56 between overlap 36 and rod 38.

In yet another embodiment of method 100 of securing or locking set-top box 58, wherein box lock 10 including mounting means 92 for mounting box lock 10, method 100 may further include: step 114 of mounting box lock 10 via mounting means 92 prior to step 110 of inserting set-top box 58 onto base 12 between first side 18 and second side 20, and front lip 14 and back lip 16.

Although the present disclosure has been described in detail, it should be understood that various changes, substitutions and alterations can be made thereto without departing from the spirit and scope of the disclosure as defined by the appended claims.

1. A box lock comprising:
a base;
a front lip;
a back lip;
a first side;
a second side; and
an openable top operable to insert a box onto said base and secure the box in the box lock between said first side and said second side, and said front lip and said back lip.

2. The box lock of claim 1, wherein said openable top being hinged to said first side and lockable to said second side, whereby said openable top being hingeable from a locked closed position to an open position for inserting and/or removing the box.

3. The box lock of claim 2, wherein said openable top being lockable to said second side via a locking system.

4. The box lock of claim 3 wherein said locking system including:
an overlap of said openable top beyond said second side; and
a rod extending from said second side below said overlap;
whereby, said overlap of said openable top being securable to said rod for locking said openable top in said locked closed position via a lock.

5. The box lock of claim 4, wherein said lock securing said overlap to said rod being a locking pin or padlock.

6. The box lock of claim 5, wherein said locking pin being a keyed locking pin.

7. The box lock of claim 5, wherein said locking system comprising:
a plate extending down from said overlap of said openable top including a first hole, and a second hole in said rod aligning with said first hole in said plate when in the closed position, whereby said lock may be inserted horizontally through said first and second holes for locking said openable top in said closed position;
a third hole through said overlap, and a fourth hole in said rod aligning with said third hole in said overlap when in the closed position, whereby said lock may be inserted vertically through said third and fourth holes for locking said openable top in said closed position; or
combinations thereof.

8. The box lock of claim 1, wherein said base being sized to support a set-top box.

9. The box lock of claim 8, wherein:
said front lip having a height sized to constrain the set-top box in the box lock and allow access to a front panel of the set-top box; and
said back lip having a height sized to constrain the set-top box in the lock and allow access to a back panel of the set-top box.

10. The box lock of claim 9, wherein:
said height of the front lip being approximately 0.38 inches;
said height of the back lip being approximately 0.38 inches; or
combinations thereof.

11. The box lock of claim 9 wherein:
said front lip including at least one front cutout for lower access areas of said front panel;
said back lip including at least one back cutout for lower access areas of said back panel;
or combinations thereof.

12. The box lock according to claim 11, wherein:
each of said front cutouts having a depth of approximately 0.13 inches;
each of said back cutouts having a depth of approximately 0.13 inches;
or combinations thereof.

13. The box lock according to claim 8, wherein:
said base having a width of approximately 11.50 inches and a depth of approximately 8.50 inches;
said first side having a height of approximately 2.00 inches and a width of approximately 2.92 inches;
said second side having a height of approximately 2.00 inches and a width of approximately 8.50 inches; and
said openable top having a width of approximately 2.92 inches, and a length of approximately 13.00 inches with said overlap of approximately 1.50 inches.

14. The box lock according to claim 1 further including a mounting means for mounting the box lock.

15. The box lock according to claim 14, wherein said mounting means including a plurality of mounting holes through said base.

16. The box lock according to claim 1, wherein said openable top, said first side, said second side, or combinations thereof expanding a portion of said base for allowing air flow to the box.

17. A method of securing or locking a set-top box comprising:
providing a set-top box lock comprising:
a base;
a front lip;
a back lip;
a first side;
a second side; and
an openable top;
removing/opening the openable top;
inserting a set-top box onto said base between said first side and said second side, and said front lip and said back lip;
locking the openable top on the set-top box lock thereby securing the set-top box inside the set-top box lock.

18. The method of securing or locking a set-top box of claim 17 wherein
said openable top being hinged to said first side and lockable to said second side, whereby said openable top being hingeable from a locked closed position to an open position for inserting and/or removing the box and said openable top being lockable to said second side via a locking system comprising:
an overlap of said openable top beyond said second side; and
a rod extending from said second side below said overlap;
whereby, said overlap of said openable top being securable to said rod for locking said openable top in said locked closed position; and
wherein said overlap of said openable top being securable to said rod via a lock being a locking pin or padlock;
wherein, said step of locking the openable top on the set-top box lock thereby securing the set-top box inside the set-top box lock including:
inserting said lock between said overlap and said rod.

19. The method of securing or locking a set-top box of claim 18, wherein
said locking pin being a keyed locking pin;
wherein, said step of locking the openable top on the set-top box lock thereby securing the set-top box inside the set-top box lock further including:
locking the locking pin between said overlap and said rod with the keyed locking pin.

20. The method of securing or locking a set-top box of claim 17, wherein
the provided box lock including a mounting means for mounting the box lock;
wherein, said method of securing or locking a set-top box further including:
mounting the box lock via the mounting means prior to said step of inserting the set-top box onto the base between the first side and the second side, and the front lip and the back lip.
